(19) United States
(12) Patent Application Publication
(10) Pub. No.: US 2015/0242053 A1
(43) Pub. Date: Aug. 27, 2015

(54) SYSTEMS AND METHODS FOR IMPROVED TOUCH SCREEN ACCURACY

(71) Applicant: QUALCOMM Incorporated, San Diego, CA (US)

(72) Inventors: Qiang Gao, San Diego, CA (US); William Yee-Ming Huang, Vista, CA (US); Hsun Wei David Wong, San Diego, CA (US); Teresa Ka Ki Ng, San Diego, CA (US); Rex Wang, San Diego, CA (US); Carol King Mui Law, San Diego, CA (US); Suhail Jalil, Poway, CA (US)

(21) Appl. No.: 14/621,153

(22) Filed: Feb. 12, 2015

Related U.S. Application Data
(60) Provisional application No. 61/943,221, filed on Feb. 21, 2014.

(51) Int. Cl. G06F 3/041

(52) U.S. Cl. CPC G06F 3/0418

(57) ABSTRACT

Systems, methods, and devices for adjusting the position of a touch input are contained herein. In one aspect, a method of correcting the position of a touch input near the edge of a touch screen and across the touch screen is disclosed. The method includes receiving a touch input, determining a position of a centroid corresponding to the touch input, determining a bias based on the position and a bias model, and determining whether to adjust the position based on the bias.

### RELATED APPLICATIONS

This application claims the benefit of U.S. Provisional Patent Application No. 61/943,221, filed Feb. 21, 2014, titled “SYSTEMS AND METHODS FOR IMPROVED TOUCH SCREEN ACCURACY WITHIN PROXIMITY OF A SCREEN EDGE,” the disclosure of which is hereby incorporated herein by reference in its entirety and for all purposes.

### BACKGROUND

1. Technical Field

The present application relates generally to touch devices, and more specifically to systems, methods, and devices for improving the accuracy of touch screens near an edge of the screen.

2. Description of the Related Art

Advances in technology have resulted in smaller and more powerful computing devices. For example, there currently exist a variety of portable computing devices, including wireless computing devices such as wireless telephones, personal digital assistants (PDAs), and tablet computers that are small, lightweight, and easily carried by users. In order to simplify user interfaces and to avoid pushbuttons and complex menu systems, such portable computing devices may use touch screen displays that detect user gestures on the touch screen and translate the detected gestures into commands to be performed by the device. Such gestures may be performed using one or more fingers or a stylus type pointing implement.

Processing overhead measures the total amount of work the central processing unit (CPU) of the device can perform and the percentage of that total capacity which is used by individual computing tasks, such as touch detection. In total, these tasks must require less than the processor's overall capacity. Simple touch gestures may typically be handled by a touchscreen controller, which is a separate processor associated with the touch screen, but more complex touch gestures require the use of a secondary processor, often the mobile device's CPU, to process large amounts of touch data. Typically, large amounts of touch data must be processed to determine the nature of the touch, sometimes only to conclude that a touch was a “false positive,” consuming large amounts of CPU capacity and device power. The processing overhead required for complex touch recognition may require a large percentage of the overall CPU capacity, impairing device performance.

The current generation of mobile processors is not well adapted to deal with increasing touch complexity and corresponding CPU overhead, especially in conjunction with the many other common high performance uses of mobile devices. Increasing the size of the mobile processor core or cache delivers performance increases only up to a certain level, beyond which heat dissipation issues make any further increase in core and cache size impractical. Overall processing capacity is further limited by the size of many mobile devices, which limits the number of processors that can be included in the device. Additionally, because mobile computing devices are generally battery-powered, high performance uses also shortens battery life.

Despite mobile processing limitations, many common mobile applications such as maps, games, email clients, web browsers, etc., are making increasingly complex use of touch recognition. Further, touch processing complexity increases proportional to touch-node capacity, which in turn increases proportional to display size. Therefore, because there is a trend in many portable computing devices toward increasing display size and touch complexity, touch processing is increasingly reducing device performance and threatening battery life. Further, user interaction with a device through touch events is highly sensitive to latency, and user experience can suffer from low throughput interfaces between the touchscreen panel and the host processor resulting in processing delay and response lag or incorrect touch position estimation for touch events near the screen edge.

### SUMMARY

The systems, methods, devices, and computer program products discussed herein each have several aspects, no single one of which is solely responsible for the desirable attributes disclosed herein. Without limiting the scope of this invention as expressed by the claims which follow, some features are discussed briefly below.

Embodiments and innovations described herein relate to systems and methods that may be run in a processor for an electronic device to correct the position of a touch input. Preferably, touch position correction methods have a wide range of controls and can be implemented in existing hardware or software. However, in some embodiments, specially designed hardware and software may improve speed or efficiencies of such processes.

One innovation of the disclosure provides a method of correcting the position of a touch input. The method includes identifying a bias model for touch positions on a touch screen, receiving a touch input from a touch screen, determining a position of a centroid corresponding to the touch input, determining a bias based on the position and the bias model, and adjusting the position based on the bias. In some aspects of the method receiving a touch input from the touch screen comprises receiving a plurality of input points, each input point including location information and an indication of the strength of the touch (for example, an x value, a y value, and an amplitude (or magnitude) value). Some aspects of the method include determining an average pointing object size, comparing a number of points corresponding to the average pointing object size and a number of points corresponding to the touch input, and determining the bias based on the comparison. In some aspects, determining an average pointing object size comprises averaging a number of touch input points present in a plurality of touch centroids.

Another innovation disclosed is an apparatus for correcting the position of a touch input. The apparatus includes a processor, a touch screen, a memory, operably connected to the processor, and configured to store instructions for the processor that when executed, cause the processor to identify a bias model for touch positions on a touch screen, receive a touch input from a touch screen, determine a position of a centroid corresponding to the touch input, determine a bias based on the position and the bias model, and adjust the position based on the bias.

In some innovations, the processor is further configured to receive a touch input from the touch screen by receiving a plurality of input points, each input point including an x value, a y value, and an amplitude. In some aspects, the memory stores processor instructions that further configure the processor to determine an average pointing object size, compare a number of points corresponding to the average pointing object size and a number of points corresponding to the touch input, and determine the bias based on the comparison. In some aspects of the apparatus determining an average pointing object size comprises averaging a number of touch input points present in a plurality of touch centroids.

Another innovation disclosed is a method of correcting the position of a touch input. The method includes receiving a touch input from a touch screen, determining a position of a centroid corresponding to the touch input, determining a bias based on the position and a bias model, and adjusting the position based on the bias. In some aspects, receiving a touch input from the touch screen comprises receiving a plurality of input points, each input point including an x value, a y value, and an amplitude. In some aspects, the method also includes determining an estimated pointing object size, determining a size of a bias region based on the estimated pointing object size; and determining a bias for the touch input based on the position of the centroid relative to the bias region.

Another innovation disclosed is an apparatus for correcting the position of a touch input. The apparatus includes a processor, a touch screen, a memory, operably connected to the processor, and configured to store instructions for the processor that when executed, cause the processor to: receive a touch input from a touch screen, determine a position of a centroid corresponding to the touch input, determine a bias based on the position and a bias model, and adjust the position based on the bias. In some aspects, the memory stores additional instructions that further configure the processor to receive a touch input from the touch screen by receiving a plurality of input points, each input point including an x value, a y value, and an amplitude. In some aspects, the memory stores processor instructions that further configure the processor to determine an estimated pointing object size, determine a size of a bias region based on the estimated pointing object size; and determine a bias for the touch input based on the position of the centroid relative to the bias region.

In one innovation, a method of adjusting the position of a touch input is disclosed. The method includes the steps of receiving a touch input, determining a centroid of the touch input, the centroid indicating an estimated touch position of the touch input on a touch panel, and determining whether to apply a bias to adjust the estimated touch position. In some aspects, receiving a touch input comprises receiving information from a plurality of touch sensors of the touch panel. In some aspects, the information from each of the plurality of touch sensors represents an x position value, a y position value, and an amplitude of the estimated touch position. In some aspects, the method further includes adjusting one or more of the x position value and the y position value of the estimated touch position based on the bias. The method may further include the steps of determining an estimated pointing object size, determining a size of a bias region based on the estimated pointing object size, and determining a bias based on the position of the centroid relative to the bias region. In some aspects, the method further includes determining a bias to apply and storing bias information in a device that comprises the touch panel. In some aspects, the bias is based on an expected size of an object making the touch input. In some aspects, determining whether to apply a bias to adjust the estimated touch position comprises comparing the touch position of the estimated position to a determined area of the touch panel, and applying the bias if the estimated touch position is within the determined area of the touch panel. In some aspects, the method further includes applying the bias to the estimated touch position to determine an adjusted estimated touch position of the touch input on the touch panel.

In another innovation, an apparatus for adjusting the position of a touch input includes a processor, a touch device, and a memory, operably connected to the processor, and configured to store instructions for the processor that when executed, cause the processor to receive a touch input, determine a centroid of the touch input, the centroid indicating an estimated touch position of the touch input on a touch panel, and determine whether to apply a bias to adjust the estimated touch position. In some aspects, receiving a touch input comprises receiving information from a plurality of touch sensors of the touch panel. In some aspects, the information from each of the plurality of touch sensors represents an x position value, a y position value, and an amplitude of the estimated touch position. In some aspects, the processor is further configured to adjust one or more of the x position value and the y position value of the estimated touch position based on the bias. In some aspects, the memory stores processor instructions that further configure the processor to determine an estimated pointing object size, determine a size of a bias region based on the estimated pointing object size, and determine a bias based on the position of the centroid relative to the bias region. In some aspects, the memory is further configured to determine a bias to apply and storing bias information in a device that comprises the touch panel. In some aspects, the bias is based on an expected size of an object making the touch input. In some aspects, determining whether to apply a bias to adjust the estimated touch position comprises comparing the touch position of the estimated position to a determined area of the touch panel, and applying the bias if the estimated touch position is within the determined area of the touch panel. In some aspects, the memory further is configured to store processor instructions that configure the processor to apply the bias to the estimated touch position to determine an adjusted estimated touch position of the touch input on the touch panel.

Yet another innovation discloses a system for adjusting the position of a touch input. The system includes a control module configured to receive a touch input, determine a centroid of the touch input, the centroid indicating an estimated touch position of the touch input on a touch panel, and determine whether to apply a bias to adjust the estimated touch position. In some aspects, receiving a touch input comprises receiving information from a plurality of touch sensors of the touch panel. In some aspects, the information from each of the plurality of touch sensors represents an x position value, a y position value, and an amplitude. In some aspects, the control module is further configured to adjust one or more of the x position and the y position of the touch position based on the bias. In some aspects, the control module is further configured to determine an estimated pointing object size, determine a size of a bias region based on the estimated pointing object size, and determine a bias based on the position of the centroid relative to the bias region. In some aspects, the control module is further configured to determine a bias to apply and store bias information in a device that comprises the touch panel, apply the bias to the estimated touch position to determine an adjusted estimated touch position of the touch input on the touch panel, and use the adjusted estimate of the touch input on the touch panel as user input for a selection on a display touch panel. The bias is based on an expected size of an object making the touch input and determining whether to apply a bias to adjust the estimated touch position comprises comparing the touch position of the estimated position to a determined area of the touch panel and applying the bias if the estimated touch position is within the determined area of the touch panel.

In another innovation, a non-transitory computer-readable medium stores instructions that, when executed, cause at least one physical computer processor to perform a method of adjusting the position of a touch input. The method includes the steps of receiving a touch input, determining a centroid of the touch input, the centroid indicating an estimated touch position of the touch input on a touch panel, and determining whether to apply a bias to adjust the estimated touch position. In some aspects, receiving a touch input comprises receiving information from a plurality of touch sensors of the touch panel. In some aspects, the information from each of the plurality of touch sensors represents an x position value, a y position value, and an amplitude. In some aspects, the method further includes adjusting one or more of the x position and the y position of the touch position based on the bias. In some aspects, the method further includes determining an estimated pointing object size, determining a size of a bias region based on the estimated pointing object size, and determining a bias based on the position of the centroid relative to the bias region. In some aspects, the method further includes determining a bias to apply, applying the bias to the estimated touch position to determine an adjusted estimated touch position of the touch input on the touch panel, and storing bias information in a device that comprises the touch panel. The bias is based on an expected size of an object making the touch input and determining whether to apply a bias to adjust the estimated touch position comprises comparing the touch position of the estimated position to a determined area of the touch panel and applying the bias if the estimated touch position is within the determined area of the touch panel.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram illustrating an example of a device that includes a touch panel and that may be configured to implement various embodiments described herein.

FIG. 2 illustrates an example of a touch input that occurs near the edge of a touch panel of a device where a portion of the touch panel that is contacted by a finger extends past the arrangement of the touch sensors.

FIG. 3 is a graph illustrating a representation of the touch input information generated for the touch input shown in FIG. 2.

FIG. 4 illustrates an example of a touch input that occurs on a touch panel of a device where a portion of the touch panel that is contacted by a finger does not extend past the arrangement of the touch sensors.

FIG. 5 is a graph illustrating a representation of the touch input information generated for the touch input shown in FIG. 4.

FIG. 6 illustrates an enlarged view of an example of a touch input that occurs near an edge of a touch panel of a device where a portion of the touch input occurs beyond the touch sensors of the touch panel and a centroid of the touch input occurs near the edge of the touch panel.

FIG. 7 illustrates a detailed view of the example touch input shown in FIG. 6 with the centroid of the touch input occurring near the edge of the touch panel and two regions indicating an area of complete touch input data and an area of incomplete touch input data.

FIG. 8 is a flowchart for adjusting the position of a centroid on a touch screen.

### DETAILED DESCRIPTION

Embodiments disclosed herein relate to touch panels that are input interfaces configured to receive a “touch input” from a user, for example, by a stylus or a user's finger(s). A touch input may also be referred to herein as a “touch event.” Many touch panels used on computers and mobile devices also include a display, allowing a user to interact with displayed information. Such computers and devices include, but are not limited to, cell phones, tablet computers, cameras, appliances, gas pumps, office equipment, communication equipment, banking equipment, automobiles, grocery and retail equipment, and a variety of other consumer and commercial devices, including both wireless and non-wireless devices.

A touch panel is configured with sensor technology to sense a location of the touch input. For example, a touch panel may include a number of sensors arranged in columns and rows across the touch panel. In most if not all touch panel implementations, a touch input generates information related to a “strength” and a “location” or “touch position” of the touch input, and the generated information can be further processed as user input. The information may be, for example, one or more signals representing the location of the touch input and the strength of the touch input. The signal(s) representing the location of the touch input indicates where on the touch panel the touch input occurred, and may be generally described as an (x,y) location on the touch panel. Because a stylus or a finger may be larger than a sensor on the touch panel, a single touch input may contact multiple sensors on the touch panel. The strength of the touch input may be determined in various ways, one example being the number of sensors that are contacted (or actuated) by the touch input. The number of actuated sensors may depend on the size of the stylus/finger touching the touch panel of the touch input, where a finger pressing hard on the touch panel will generally actuate more touch sensors because the finger is flattened out. The number of actuated sensors may also depend on the size of the sensors and the configuration of the sensors on the touch panel. In another example, the strength may be determined by the length of time a touch input is made on the touch panel. In another example, the strength of the touch input may be determined based on the amount of physical deflection that occurs on the touch panel as a result of the touch. As one having ordinary skill in the art will appreciate, the particular information generated by the touch input relating to the location and strength of the touch input may be based on the technology of a particular touch panel.

The sensors of a touch panel are generally small so that when a touch input is made by a user with a finger or a stylus, multiple sensors may detect the touch input. Generally more sensors detect a touch input when a finger, rather than a stylus, is used due to a larger contact surface of a finger. To determine an (estimated) exact location of what a user was intending to touch when multiple touch sensors are actuated by the touch input, a touch panel may process information received from the multiple touch sensors and determine a “center” of the touch input. In some embodiments, a centroid of the touch input is determined based on the information received from actuated multiple touch sensors. The centroid (or geometric center) of the touch input region may be generally defined as the arithmetic mean position of all the sensors in the footprint of the touch input, that is, the mean position of all the sensors that are actuated. Because information from the touch sensors indicate a signal strength of the touch input for that sensor, the sensor position and the strength of each touch sensor may be used to determine a centroid of the touch input (for example, by weighting each actuated sensor by the strength of the touch on that sensor), and the location of the centroid is used as the intended touch point on the touch panel.

On many display touch panels, a touch input made on the touch panel near the edge of the touch panel may generate less information, and thus be less accurate, than a touch input made in the middle of the touch panel because the touch panel may not have touch sensors disposed near the edges of the touch panel, even though it may appear to a user that they should be able to make a touch input near the edge of the display touch panel. Additionally, a touch input received at, or near, the edge of a touch panel may be partially off the touch panel resulting in inaccurate information being generated by the touch panel. For example, when a user makes a touch input on an icon displayed at the edge of a display touch panel, the user's finger, when it is in contact with the touch panel display, may extend past the edge of the touch panel display resulting in inaccurately generated touch information. Additionally, depending on the technology of a touch panel, the electronic noise and shadows (for example, caused by the stylus or finger) may lead to an inaccuracy in a touch input. Because of such inaccuracies, touch inputs made near the edge of a touch panel may need to be made more than once to correctly indicate a user's desired input. Problems relating to accuracy of a touch input may also occur anywhere on the touch panel. To address such issues, embodiments described herein may process information received from a touch input near the edge of a display to provide a more accurate determination of the location and strength of the touch input, resulting in a more accurate and more efficient input touch panel interface. For example, a calculated center position (for example, a centroid) may be adjusted to remove bias in its position that is a result of having incomplete touch sensor information.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

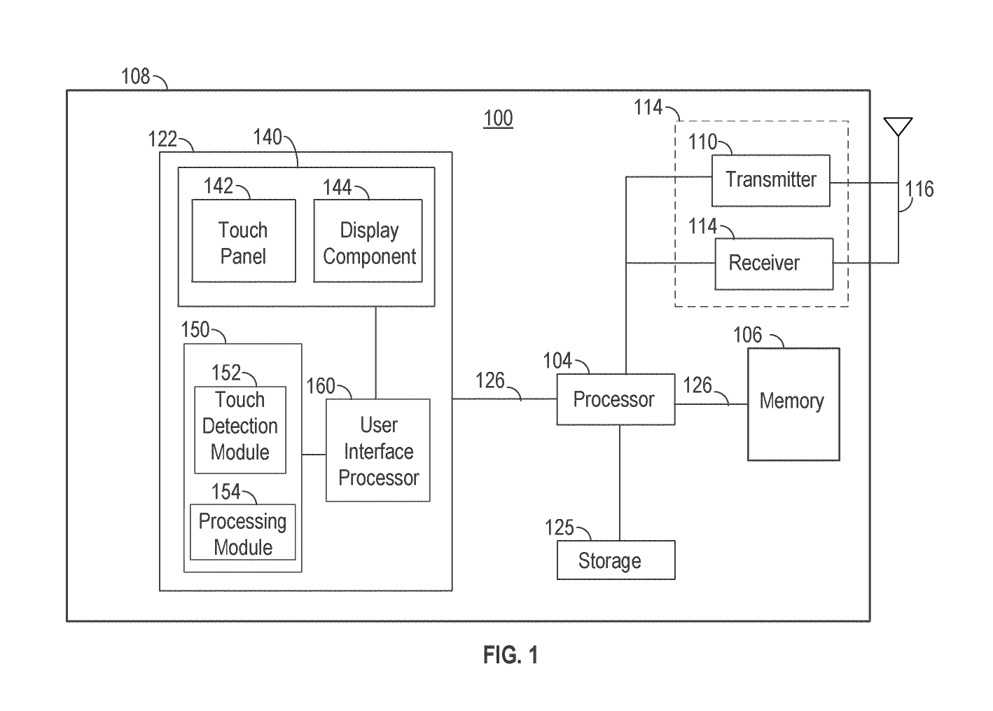

FIG. 1 illustrates an example of a device 100 that includes a touch panel and that may be configured to implement various embodiments described herein. Device 100 is illustrated as being a wireless device, however, other embodiments include a variety of wired and wired devices, mobile and non-mobile devices, consumer and commercial devices, for example, as described hereinabove.

As shown in the embodiment illustrated in FIG. 1, device 100 includes a processor 104 which is configured to control operations of the device 100. The processor 104 may also be referred to as a central processing unit (CPU). The device 100 also includes a memory component 106 which is in communication with the processor 104 via a bus system 126. Memory component 106 may include both read-only memory (ROM) and random access memory (RAM), and may store instructions and data that can be accessed and used by the processor 104. A portion of the memory component 106 may also include non-volatile random access memory (NVRAM). The processor 104 is configured to perform operations (for example, logical and arithmetic operations) based on program instructions that are stored in the memory component 106. The instructions in the memory component 106 may be executable to implement the methods described herein. The device 100 may also include another storage component 125 that is in communication with the processor 104, and that is configured to store information that can be accessed by the processor 104, and/or instructions for controlling the operation of the processor 104 or any other component of device 100. Although not explicitly shown, the device 100 may be configured such that another processor of device 104 (for example, user interface processor 160) may also be in communication with the storage component 125.

The processor 104 is representative of a processing system that may include one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Such a processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

FIG. 1 further illustrates that the device 100 embodiment may also include a housing 108, which can be, for example, a mobile device housing, a housing of an appliance, or office equipment. In some embodiments, the components described in reference to FIG. 1 as being in housing 108 may be instead disposed within a piece of equipment (for example a copier) that has a housing that generally contains illustrated components and man additional components. In this embodiment, the device 100 further includes a transmitter 110 and/or a receiver 112 which are disposed in the housing 108. The transmitter 110 and receiver 112 are configured to transmit and receive data, communicating data between the device 100 and another device. The transmitter 110 and receiver 112 may be combined into a transceiver 114. The device 100 may also include an antenna 116 that may be electrically coupled to the transceiver 114. Various embodiments of the device 100 may also include multiple transmitters, multiple receivers, multiple transceivers, and/or multiple antennas (not shown).

The transmitter 110 may be configured to wirelessly transmit packets having different packet types or functions. For example, the transmitter 110 may be configured to transmit packets of different types generated by the processor 104. When the device 100 is implemented or used as an access point or station, the processor 104 may be configured to process packets of a plurality of different packet types. For example, the processor 104 may be configured to determine the type of packet and to process the packet and/or fields of the packet accordingly. The receiver 112 may be configured to wirelessly receive packets having different packet types. In some aspects, the receiver 112 may be configured to detect a type of a packet used and to process the packet accordingly.

The device 100 may also include a signal detector 118 that may be used in an effort to detect and quantify the level of signals received by the transceiver 114. The signal detector 118 may detect such signals as total energy, energy per subcarrier per symbol, power spectral density and other signals.

The device 100 may further comprise a user interface 122 that includes a touch panel 142). The user interface 122 may include any element or component that conveys information to a user of the device 100 and/or receives input from the user. Systems and methods for improving the accuracy of touch position estimates near the screen edge can be implemented in device 100.

As illustrated in the embodiment of FIG. 1, various components of the device 100 may be coupled together by and communicate using the bus system 126 The bus system 126 may include a data bus, for example, as well as a power bus, a control signal bus, and a status signal bus in addition to the data bus. The components of the device 100 may also be coupled together or provide information or data to each other using some other mechanism.

Although a number of separate components are illustrated in FIG. 1, one or more of the components may be combined or commonly implemented. Further, each of the components illustrated in FIG. 1 may be implemented using a plurality of separate elements. As illustrated in the embodiment of FIG. 1, the user interface 122 may include a display 140 and a touch screen subsystem 150. The user interface 122 may also include a user interface processor 160 to perform operations associated with the user interface. In some embodiments, processor 104 (or another processing component in the device 100) may perform operations to control the display of data on the display component 140 and to receive touch inputs from the user interface 122. The illustrated embodiment is not meant to be limiting and device 100 may include a variety of other components as required for other functions.

The display 140 of the user interface 122 may include a touch panel 142. The touch panel 142 may be incorporated in a display 140. In various embodiments, the display 140 may include, for example, LED, LCD of plasma technology to display information. The display 140 also may include a display component 144, which may be, in some embodiments, coupled to a user interface processor 160 or processor 104 for receiving information (for example, images, text, symbols or video) to display visually to a user.

The touch panel 142 may have implemented therein one or a combination of touch sensing technologies, for example, capacitive, resistive, surface acoustic wave, or optical touch sensing. In some embodiments, touch panel 142 may be positioned over (or overlay) display component 144 in a configuration such that visibility of the display component 144 is not impaired. In other embodiments, the touch panel 142 and display component 144 may be integrated into a single panel or surface. The touch panel 142 may be configured to operate with display component 144 such that a touch input on the touch panel 142 is associated with a portion of the content displayed on display component 144 corresponding to the location of the touch on touch panel 142. Display component may also be configured to respond to a touch input on the touch panel 142 by displaying, for a limited time, a visual representation of the touch.

Still referring to the embodiment of FIG. 1, touch panel 142 is coupled to a touch screen subsystem 150 that includes a touch detection module 152 and a processing module 154. The touch panel 142 may operate with touch screen subsystem 150 to sense the location, pressure, direction and/or shape of a user touch or touches on display 140. The touch detection module 152 may include instructions that when executed scan the area of the touch panel 142 for touch events and provide the coordinates of touch events to the processing module 154.

The processing module 154 may be configured to analyze touch events, including adjusting touch position estimates as described in further detail below to improve the accuracy of the touch position, and to communicate touch data to user interface processor 160. The processing module 154 may, in some embodiments, include instructions that when executed act as a touch screen controller (TSC). The specific type of TSC implemented can depend on the type of touch technology used in touch panel 142. The processing module 154 may be configured to start up when the touch detection module 152 indicates that a touch input has occurred on touch panel 142, and to power down after release of the touch. This feature may be useful for power conservation in battery-powered devices.

Processing module 154 may be configured to perform filtering on touch input information received from the touch detection module 152. For example, in an embodiment of the display 140 where the touch panel 142 is disposed on top of a display component 144 that includes a LCD screen, the LCD screen may contribute noise to the coordinate position measurement of the touch input. This noise may be a combination of impulse noise and Gaussian noise. The processing module 154 may be configured with median and averaging filters to reduce this noise. Instead of using only a single sample for a coordinate measurement of the touch input, the processing module 154 may be programmed to instruct the touch detection module 152 to provide more than one sample (e.g., two, four, eight, or 16 samples). These samples may then be sorted, median filtered, and averaged to give a lower noise, more accurate result of the touch coordinates.

In some embodiments, the processing module 154 can be a processor specifically configured for use with the touch screen subsystem 150, while user interface processor 160 may be configured to handle the general processing requirements of the user interface. The processing module 154 and the user interface processor 160 may be in communication with each other. In various embodiments, the processing described as being performed by user interface processor 160, processing module 154, and processor 104 may performed in different processors or a single processor.

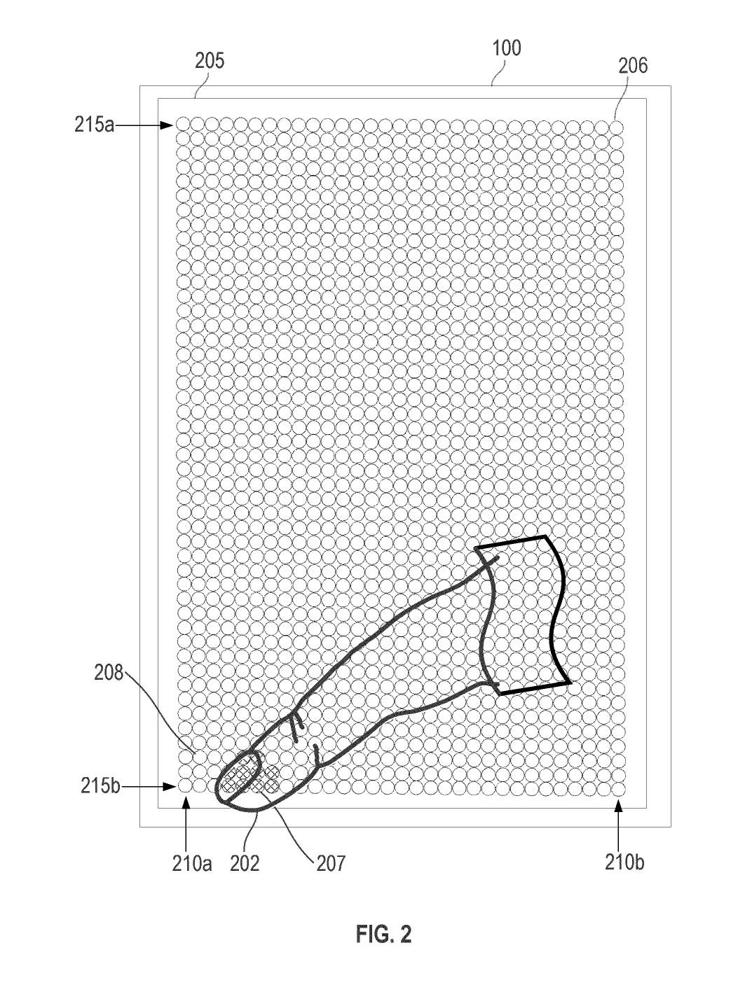

FIGS. 2-5 illustrate examples of two touch inputs and the information that may be received from each one. FIG. 2 illustrates an example of a touch input that occurs on the edge of a touch panel 205 of a device 100 where a portion of the touch panel 205 that is contacted by a finger 202 extends past the arrangement of the touch sensors 206. The touch panel 205 includes a plurality of touch sensors 206 arranged in a grid of columns (that is, aligned with the vertical orientation of FIG. 2) and rows (that is, aligned with the horizontal orientation of FIG. 2). The touch panel 205 includes two columns of border sensors 210a, 210b and two rows of border sensors 215a, 215b disposed along the edges of the arrangement of touch sensors 206. The user's finger 202 is illustrated making a touch input and contacts a portion of the touch panel 205 actuating multiple touch sensors 207 (illustrated with crosshatching). Touch sensors 208 (illustrated as circles with no cross-hatching) are not actuated by the touch input.

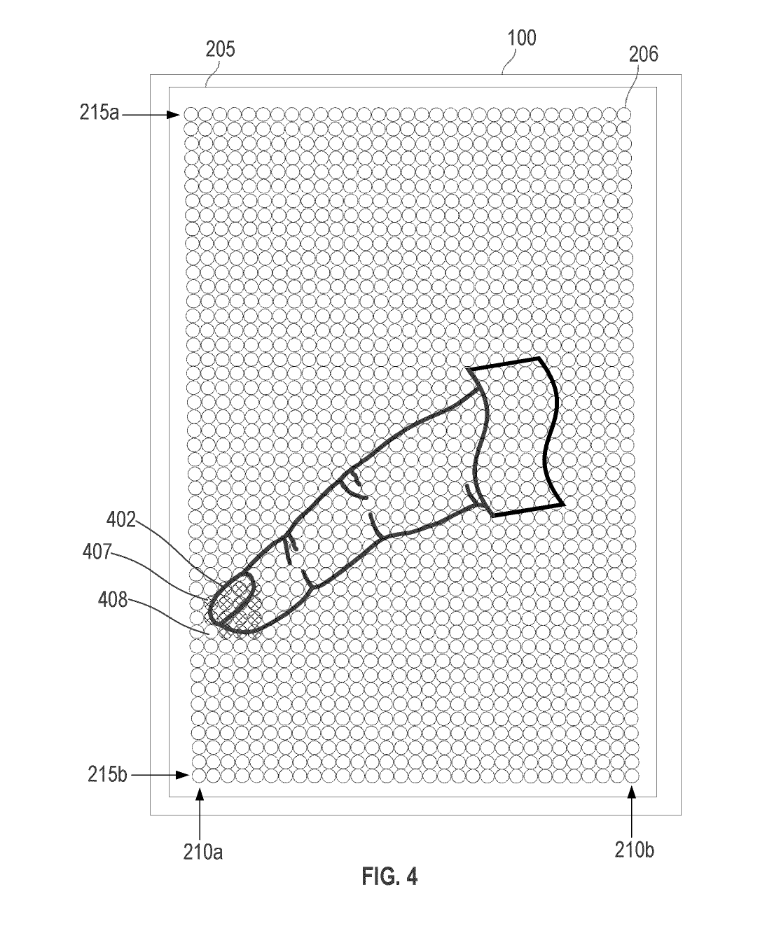

As illustrated in FIG. 2, in this example there are ten actuated touch sensors 207 by this touch input, and each of these touch sensors 207 provides information (for example, one or more signals) indicative of its actuation. The information may include the location of the touch sensor (for example, an x,y location) and the strength (e.g., amplitude or magnitude) of the touch input. Because the contact of the finger 202 extends past the row of border sensors 215b, fewer touch sensors are actuated compared to a touch input made completely within the touch panel 205 (for example, in the interior of the touch panel 205 where no border sensors are actuated as illustrated in the example of FIG. 4). Accordingly, although a centroid of the touch input may be calculated, information needed to accurately determine a centroid of the touch input is not generated. For example, a centroid generated from the touch input illustrated in FIG. 2 may be at a touch sensor that is not one of the border row of touch sensors 215b even though that is what was intended by the user.

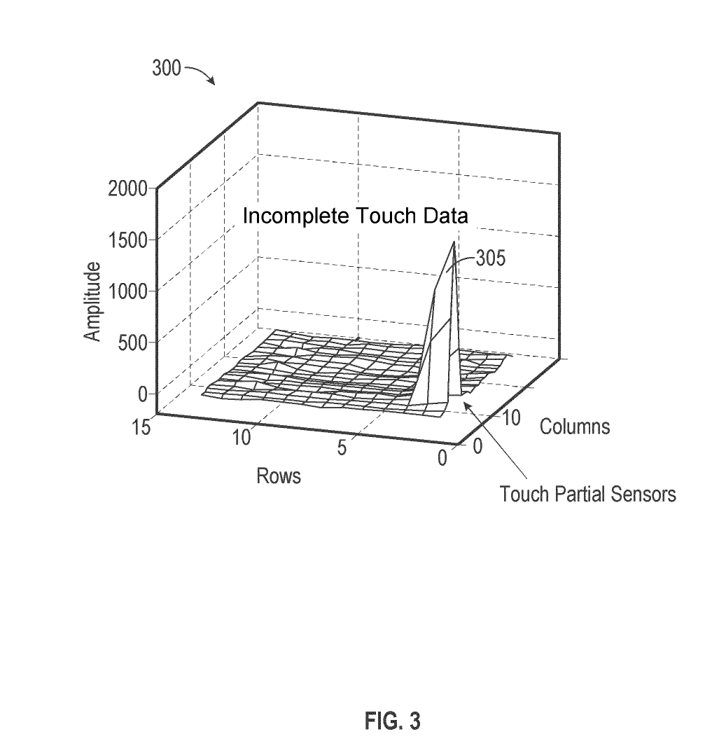

FIG. 3 is a graph 300 illustrating a representation of the touch input information generated for the touch input shown in FIG. 2 (note: the graph 300 is not to scale). The y-axis of graph 300 corresponds with the length of the touch panel 205 (FIG. 2) and the x-axis corresponds with the width of the touch panel 205. The z-axis of graph 300 labeled “amplitude” represents the strength of a touch input made on an actuated touch sensor. Graphed data 305 illustrates the touch input corresponding to FIG. 2 where the contact area of the finger extended past the touch panel 205 (values along z-axis included to merely represent a strength scale). The touch data 305 appears to end abruptly at the edge of the graphed touch input information, indicating that sensed information of the full contact area of the touch input was not generated. In other words, the graph 300 indicates an instance of incomplete touch information. Accordingly, a centroid formed from this data tends to be inaccurate. For example, a user may have intended to touch a border sensor. When a centroid (or a center touch point) is determined using the incomplete touch information, the centroid may indicate a touch sensor that is not a border sensor because information that would have moved the centroid (outward) towards a border row of touch sensors 215a (FIG. 2) is missing.

FIG. 4 illustrates an example of a touch input that occurs away from the edge of the touch panel 205 of the device 100 where a portion of the touch panel that is contacted by a finger does not extend past the arrangement of the touch sensors 206. A user's finger 402 is shown making a touch input and contacts a portion of the touch panel 205 actuating 10 touch sensors 407 (illustrated with crosshatching). Touch sensors 408 (illustrated as circles with no cross-hatching) are not actuated by the touch input.

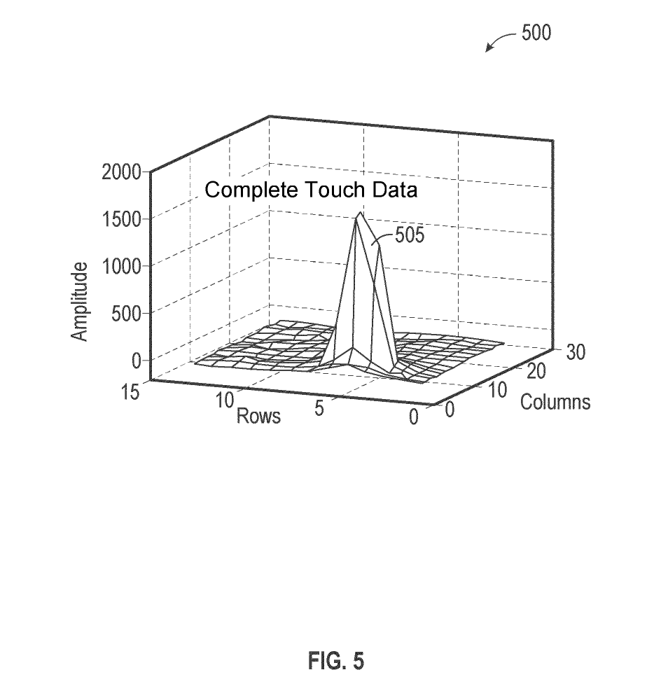

FIG. 5 is a graph 500 illustrating a representation of the touch input information generated for the touch input shown in FIG. 4 (note: the graph 500 is not to scale). The y-axis of graph 500 corresponds with the length of the touch panel 205 of FIG. 4 and the x-axis corresponds with the width of the touch panel 205. The z-axis of graph 500 labeled amplitude represents the relative strength of the touch input made on an actuated touch sensor. Graphed data 505 illustrates the touch input corresponding to FIG. 4 where the contact area of the finger does not extend past the edge of the touch panel 205. The touch data 505 does not appear to indicate any abrupt edges, indicating that sensed information of the full contact area of the touch input was generated. In other words, the graph 500 indicates an instance of complete touch information. Accordingly, a centroid may be determined to be at a certain location, based on the touch event depicted in FIG. 5, is more likely to be at the true centroid of a finger 402 contact area with the touch panel 205 because it included information from the entire area of the finger 402 contact area. That is, the centroid calculation, however it was done, used as much data as would normally be possible and did not have incomplete data due to the finger 402 contact area extending past the arrangement of touch sensors 206.

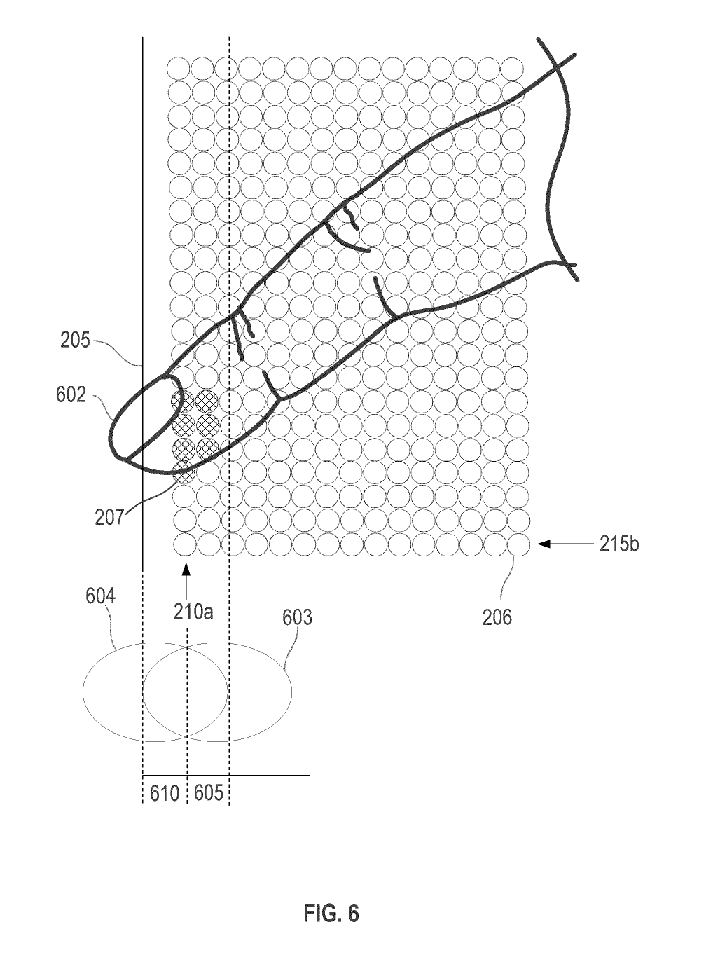

FIG. 6 illustrates aspects that can be used to adjust the determined position of a touch input according to various embodiments. For example, adjusting the touch position by biasing actuated touch sensors near the edge of a touch panel to increase their strength information may result in improved accuracy of the touch position estimation both near the edge of the touch panel. Biasing may also improve accuracy across the full surface of the touch panel. Incomplete sensor data due to a touch input close to the edge of the touch panel may cause the estimation of the centroid of the touch position to be inaccurate. FIG. 6 illustrates an example of a touch input made by finger 602 that is similar to the touch input shown in FIG. 2, that is, a touch input close to the edge of the touch panel 205 where the finger 602 extends past the column of border sensors 210a. In the illustrated touch input, the finger 602 activates sensors 207 (cross-hatched) including four sensors in the border column of sensors 210a.

FIG. 6 illustrates two touch regions that represent examples of the area that a finger 602 would contact the touch panel 205 in two touch inputs. In particular, FIG. 6 illustrates the relative alignment of a first region 604, a second regions 603 and a bias area 605 with an illustrated finger touch input First region 604 (depicted below the touch panel for clarity of the figure) indicates a touch input where the contact (or near contact) of the finger 602 to the touch panel 205 extends past the edge of the touch panel 205 (that is, the portion of the first region 604 in FIG. 6 to the left of where the touch panel 205 ends). A portion of the first region 604 also extends into the touch panel sensors 206. That is, first region 604 extends to the right of a line aligned with the column of border sensors 210a. FIG. 6 also illustrates a second region 603 (depicted below the touch panel for clarity of the figure) that indicates a touch input where the contact (or near contact) of the finger 602 to the touch panel 205 extends from the edge of the touch panel 205 into the arrangement of touch sensors 206. The area 610 indicates the area from the column of border sensors 210a to the edge of the touch panel 205. The area 605 indicates a bias region that extends from the columns of border sensors into the touch sensors 206 a certain distance. The touch input shown in FIG. 6 by finger 602 results in incomplete touch data (similar to that as illustrated in FIG. 3). To increase the accuracy of a centroid determined using the actuated touch sensors 206, an amount of bias may be included to increase the strength of touch sensors that are larger to the edge of the touch panel 205. The first region 603 and the second regions 604 overlap near the border sensor column 210a in an area shown by 605 and 610. A touch input in this area 610 and 605 will have incomplete sensor data due to the lack of touch sensors between the column of border sensors 210a and the edge of the touch panel 205.

When a centroid of a touch input is determined to be outside or to the right of the bias region 605, there is complete sensor data for the touch input, as shown in FIG. 5. If the centroid is determined to be near the edge of the touch screen and within the bias region 605, (that is, within a portion of the first region 604 and a portion of the second regions 603), there is incomplete touch sensor data for the touch input, and a centroid generated based on the information from the touch sensors has bias.

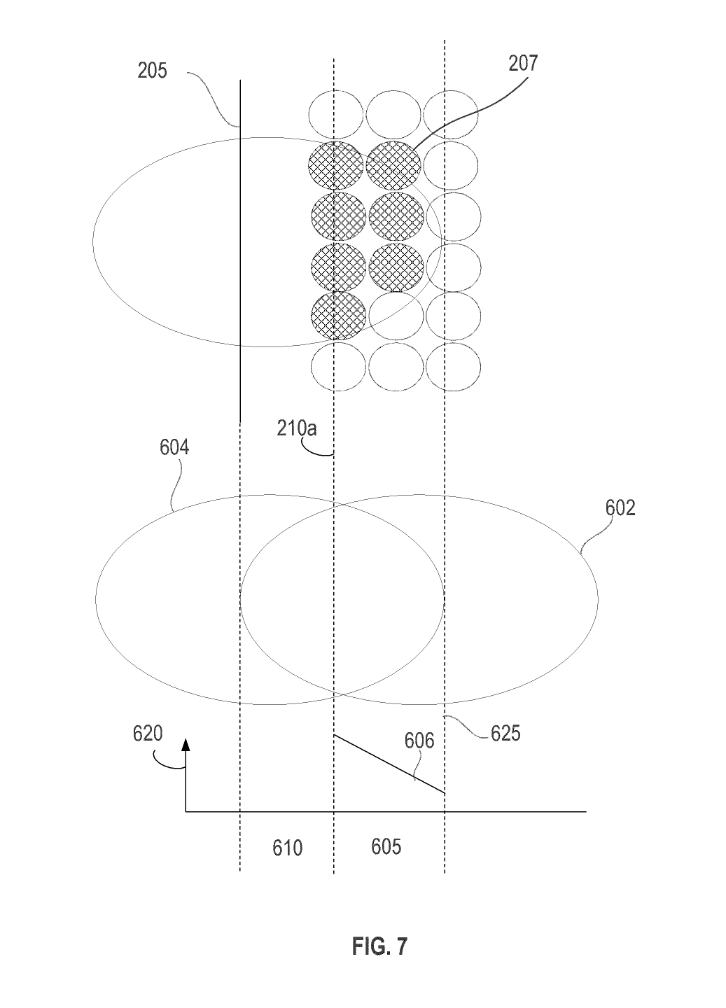

To correct the touch position centroid estimation when incomplete touch sensor information is available, the bias may be mitigated or removed in accordance with a bias model. FIG. 7 illustrates one example of an embodiment of a bias model 606 that may be used to correct a touch position estimation that is based on a centroid of a touch input when incomplete touch sensor information is available. The first region 604 corresponds to incomplete touch sensor information for a touch input made near the edge of the touch panel 205, as indicated by the activated sensors 207. In this bias model 606, bias increases linearly the closer the touch input is to the edge of the touch panel 205. Accordingly, a determined centroid near the edge of the touch panel 205 can be adjusted, in either a horizontal or lateral direction (x-direction) of the touch panel 205 and/or a vertical or longitudinal direction (y-direction) of the touch panel 205 to mitigate or remove the bias resulting in an adjusted centroid position that more accurately determines the true centroid position of a touch input. While the illustration in FIG. 7 illustrates a bias model 606 to correct either a horizontal or a vertical x or y position of a determined (estimated) centroid of a touch input, a similar bias removal (or mitigation) process may be used to improve the accuracy of the centroid estimation of the touch position in both the horizontal and vertical directions x and y directions.

FIG. 7 illustrates one example of an embodiment of a linear bias model 606. Other bias models may be used in other embodiments. For example, based on theoretical analysis and simulations, a bias model may be approximated, in one aspect, by a line or by a different line or curve. Note that the bias model may be a two dimensional function that jointly models the bias in the x and y directions. Once a bias model is defined and identified, if an estimated position is within the bias region 605, the estimated position may be adjusted according to the bias model. This may also compensate for the bias and improve the touch position accuracy everywhere on the touch panel by defining where on a touch panel to implement a bias removal process. In some embodiments, both an original x coordinate and an original y coordinate of the original touch input may be used to estimate the bias and provide an improved estimated centroid position. In some embodiments, an original x coordinate or an original y coordinate of the original touch input may be used to estimate the bias and provide an improved estimated centroid position.

In some embodiments, as shown in FIG. 7, the bias region 605 extends from a border sensor 210a to some distance towards the interior of the touch panel 205. In some embodiments, the bias region 605 may extend 1 mm to 3 mm towards the interior of the touch panel 205 from the column of border sensors 210a. The width of the bias region 605 may be determined by simulation. In some embodiments, the bias model 606 shown in FIG. 7 is determined initially offline using measurements, calculations or numeric models based on expected finger size or the expected shape of the touch input. Once the bias model 606 is numerically calculated or estimated, it can be used to determine the bias for an estimated touch position and the estimated centroid of the touch position in both the x and y directions for touch inputs along the edge of the sensor and across the entire surface of the touch panel 205 may be improved by subtracting the bias from the estimated centroid position.

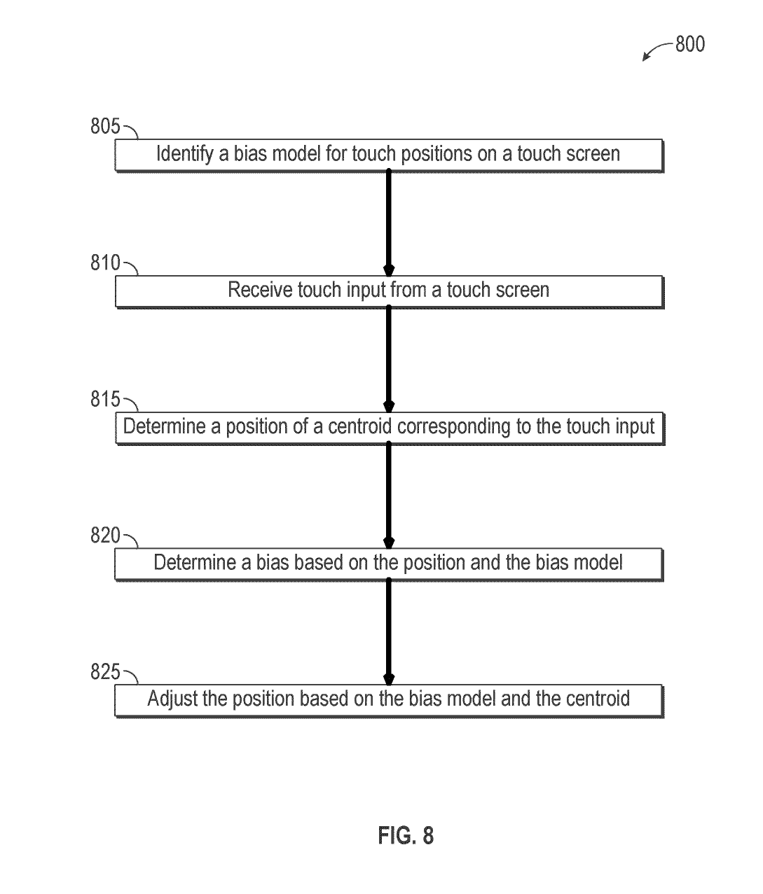

FIG. 8 is a flowchart for adjusting the position of a centroid on a touch panel. In some aspects, process 800 may be performed by the device 100. In some other embodiments, the method 800 may be performed on any device having a touch screen, such as a copier or an automated teller machine. In some embodiments, process 800 may be performed by the processor 104 or the user interface processor 160 of the device 100.

In block 805, a bias model is identified for a touch position on a touch panel. In some aspects, a bias model may be developed during research and development of a particular model of touch panel or determined as discussed in greater detail above. The bias model may be embedded within device 100 so that the model may be referenced during run-time. For example, software and/or firmware logic processing input from a touch panel may reference the model. In some embodiments, block 805 is not performed.

In block 810, touch input is received from a touch panel, such as touch panel 142. In some aspects, the touch input may include amplitude values received from a plurality of touch sensors, such as touch sensors 206. For example, amplitude values for touch sensors within a proximity of a touch spike, such as the maximum of the touch data 305 or data 505 may be received. In some aspects, at least a portion of the received touch input may correspond to input related to a finger or other object touching or coming within a proximity of a sensor 206 of a touch panel 205. The touch input may generate information from a plurality of touch sensors, with the information from each touch sensor including x and y coordinate values, and an amplitude value, as discussed above with respect to FIGS. 3 and 5.

In block 815, a position of a centroid corresponding to the touch input is determined. In some embodiments, the centroid may be determined in some aspects via a weighted average of the input values received in block 810. For example, the x values for each of the plurality of touch sensor data points included in the touch input of block 810 may be weighted based on the data point's amplitude value. A weighted average of the x values may then be used to determine the centroid position. A similar calculation may be performed with respect to the y values of the touch sensor data points.

In block 820, a bias may be determined based on the position of the touch input and the bias model. In some aspects, a bias provided by the bias model may be based on the number of sensor data points included within a touch input. For example, some embodiments may include estimation of a finger (or other pointing object) size. For example, the size of the finger or pointing object may correspond to a number of touch sensor data points having an amplitude above a predetermined threshold when a touch event occurs.

Determination of the bias may be further based on the estimated pointing object size. For example, the size of the bias region 605 illustrated in FIGS. 6 and 7 may be based on the estimated pointing object size. For example, in some embodiments, the size of the bias region 605 may be proportional to the size of the estimated pointing object size. The bias model 606 is then applied over the bias region 605.

In block 825, the position of the centroid of the touch input is adjusted based on the bias and the estimated centroid position. For example, removal or mitigation of the bias may move the position of the centroid towards an edge of the touch panel 205 when the number of touch sensors included in the centroid calculation is less than the number of touch sensors for a touch input having complete sensor data.

### Clarification Regarding Terminology

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It is noted that examples may be described as a process, which is depicted as a flowchart, a flow diagram, a finite state diagram, a structure diagram, or a block diagram. Although a flowchart may describe operations as a sequential process, many of the operations can be performed in parallel, or concurrently, and the process can be repeated. In addition, the order of operations may be re-arranged. A process may be deemed to be terminated when its operations are completed. A process may correspond to a method, a function, a procedure, a subroutine, a subprogram, etc. When a process corresponds to a software function, its termination may correspond to a return of the function to the calling function or the main function. A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of adjusting the position of a touch input, comprising:
receiving a touch input;
determining a centroid of the touch input, the centroid indicating an estimated touch position of the touch input on a touch panel; and
determining whether to apply a bias to adjust the estimated touch position.

2. The method of claim 1, wherein receiving a touch input comprises receiving information from a plurality of touch sensors of the touch panel.

3. The method of claim 2, wherein the information from each of the plurality of touch sensors represents an x position value, a y position value, and an amplitude of the estimated touch position.

4. The method of claim 3, further comprising adjusting one or more of the x position value and the y position value of the estimated touch position based on the bias.

5. The method of claim 1, further comprising:
determining an estimated pointing object size;
determining a size of a bias region based on the estimated pointing object size; and
determining a bias based on the position of the centroid relative to the bias region.

6. The method of claim 1, further comprising determining a bias to apply and storing bias information in a device that comprises the touch panel.

7. The method of claim 1, wherein the bias is based on an expected size of an object making the touch input.

8. The method of claim 1, wherein determining whether to apply a bias to adjust the estimated touch position comprises comparing the touch position of the estimated position to a determined area of the touch panel, and applying the bias if the estimated touch position is within the determined area of the touch panel.

9. The method of claim 1, further comprising applying the bias to the estimated touch position to determine an adjusted estimated touch position of the touch input on the touch panel.

10. An apparatus for adjusting the position of a touch input, comprising:
a processor;
a touch device; and
a memory, operably connected to the processor, and configured to store instructions for the processor that when executed, cause the processor to
receive a touch input;
determine a centroid of the touch input, the centroid indicating an estimated touch position of the touch input on a touch panel; and
determine whether to apply a bias to adjust the estimated touch position.

11. The apparatus of claim 10, wherein receiving a touch input comprises receiving information from a plurality of touch sensors of the touch panel.

12. The apparatus of claim 11, wherein the information from each of the plurality of touch sensors represents an x position value, a y position value, and an amplitude of the estimated touch position.

13. The apparatus of claim 12, wherein the processor is further configured to adjust one or more of the x position value and the y position value of the estimated touch position based on the bias.

14. The apparatus of claim 10, wherein the memory stores processor instructions that further configure the processor to:
determine an estimated pointing object size;
determine a size of a bias region based on the estimated pointing object size; and
determine a bias based on the position of the centroid relative to the bias region.

15. The apparatus of claim 10, wherein the memory is further configured to determine a bias to apply and storing bias information in a device that comprises the touch panel.

16. The apparatus of claim 10, wherein the bias is based on an expected size of an object making the touch input.

17. The apparatus of claim 10, wherein determining whether to apply a bias to adjust the estimated touch position comprises comparing the touch position of the estimated position to a determined area of the touch panel, and applying the bias if the estimated touch position is within the determined area of the touch panel.

18. The apparatus of claim 11, wherein the memory further is configured to store processor instructions that configure the processor to apply the bias to the estimated touch position to determine an adjusted estimated touch position of the touch input on the touch panel.

19. A system for adjusting the position of a touch input, comprising:
a control module configured to
receive a touch input;
determine a centroid of the touch input, the centroid indicating an estimated touch position of the touch input on a touch panel; and
determine whether to apply a bias to adjust the estimated touch position.

20. The system of claim 19, wherein receiving a touch input comprises receiving information from a plurality of touch sensors of the touch panel.

21. The system of claim 20, wherein the information from each of the plurality of touch sensors represents an x position value, a y position value, and an amplitude.

22. The system of claim 21, wherein the control module is further configured to adjust one or more of the x position and the y position of the touch position based on the bias.

23. The system of claim 19, wherein the control module is further configured to:
determine an estimated pointing object size;
determine a size of a bias region based on the estimated pointing object size; and
determine a bias based on the position of the centroid relative to the bias region.

24. The system of claim 19, wherein the control module is further configured to determine a bias to apply and store bias information in a device that comprises the touch panel, apply the bias to the estimated touch position to determine an adjusted estimated touch position of the touch input on the touch panel, and use the adjusted estimate of the touch input on the touch panel as user input for a selection on a display touch panel, wherein the bias is based on an expected size of an object making the touch input and determining whether to apply a bias to adjust the estimated touch position comprises comparing the touch position of the estimated position to a determined area of the touch panel and applying the bias if the estimated touch position is within the determined area of the touch panel.

25. A non-transitory computer-readable medium storing instructions that, when executed, cause at least one physical computer processor to perform a method of adjusting the position of a touch input, the method comprising:
receiving a touch input;
determining a centroid of the touch input, the centroid indicating an estimated touch position of the touch input on a touch panel; and
determining whether to apply a bias to adjust the estimated touch position.

26. The non-transitory computer-readable medium of claim 25, wherein receiving a touch input comprises receiving information from a plurality of touch sensors of the touch panel.

27. The non-transitory computer-readable medium of claim 26, wherein the information from each of the plurality of touch sensors represents an x position value, a y position value, and an amplitude.

28. The non-transitory computer-readable medium of claim 27, further comprising adjusting one or more of the x position and the y position of the touch position based on the bias.

29. The non-transitory computer-readable medium of claim 25, further comprising:
determining an estimated pointing object size;
determining a size of a bias region based on the estimated pointing object size; and
determining a bias based on the position of the centroid relative to the bias region.

30. The non-transitory computer-readable medium of claim 25, further comprising determining a bias to apply, applying the bias to the estimated touch position to determine an adjusted estimated touch position of the touch input on the touch panel, and storing bias information in a device that comprises the touch panel, wherein the bias is based on an expected size of an object making the touch input and determining whether to apply a bias to adjust the estimated touch position comprises comparing the touch position of the estimated position to a determined area of the touch panel and applying the bias if the estimated touch position is within the determined area of the touch panel.
